(19) United States
(12) Patent Application Publication
(10) Pub. No.: US 2019/0110112 A1
(43) Pub. Date: Apr. 11, 2019

(54) VIDEO STREAMING SYSTEM WITH PARTICIPANT TRACKING AND HIGHLIGHT SELECTION

(71) Applicant: Six Star Services LLC, Houston, TX (US)

(72) Inventor: David Maloney, Houston, TX (US)

(21) Appl. No.: 16/154,120

(22) Filed: Oct. 8, 2018

Related U.S. Application Data
(60) Provisional application No. 62/569,321, filed on Oct. 6, 2017.

(51) Int. Cl. H04N 21/8549; H04N 21/218; H04N 7/18; G06K 9/00; G06Q 30/06; H04N 21/475

(52) U.S. Cl. CPC H04N 21/8549; H04N 21/21805; H04N 7/188; G06K 2009/00738; G06K 9/00724; G06Q 30/06; H04N 21/4756; G06K 9/00288

(57) ABSTRACT

A system for automatically presenting video of a sporting event tracks competitors automatically and presents the video stream to a subscriber interface. The system automatically switches between streams as the competitor changes events. The subscriber interface may have elements to present a call to action to the user.

### CROSS REFERENCES TO RELATED APPLICATIONS

This application claims the benefit of U.S. Provisional Patent Application Ser. No. 62/569,221, entitled “VIDEO STREAMING SYSTEM WITH PARTICIPANT TRACKING AND DONATION INTERFACE,” filed Oct. 10, 2017;

This application is related to U.S. Provisional Patent Application No. 62/591,607 filed Nov. 28, 2017 entitled “VIDEO STREAMING SYSTEM WITH PARTICIPANT TRACKING AND HIGHLIGHT SELECTION”.

The entire disclosures of applications recited above are hereby incorporated by reference, as if set forth in full in this document, for all purposes.

### FIELD OF THE INVENTION

The present disclosure generally relates to video streaming. The disclosure relates more particularly to apparatus and techniques for performing selection of one stream from multiple streams to track a participant as the participant engages in various events that are captured in video or images.

### BACKGROUND

For sporting events, the performances can be recorded and viewed live or at later times. In typical sporting events, there are many participants and some viewers might only be interested in a subset of the participants. For broadcast television and other professionally edited coverage, there are decisions that producers and directors make about what camera imagery to include, what to edit, what order to present it in, and the like. Some events allow for the viewer to select among a small set of pre-determined options, such as different camera angles. Often the goal of a video presentation of a sporting event is to highlight the competition among teams, plays deemed to be exciting to a generalized audience, any available drama, suspense and the like.

For some events, sporting or otherwise, a viewer's interest and focus can be different that the interest and focus of other viewers, even while viewing the same event. In a sporting event, different viewers might have interests related to different players, teams or aspects of the event. It may be that when faced with a choice of indeterminate viewing of an event, a viewer would instead opt for some other activity, but would view if it were possible to focus only on those portions of interest to the viewer.

Some sporting events are used to facilitate raising money for charitable causes, such as marathons, celebrity golfing, and the like. Aspects and portions of the events are often recorded with cameras for later viewing, but using recording systems in the same way as for competitive sporting events in official leagues can be less than desirable for charitable events. Aspects and portions of events recorded with cameras for later viewing may vary depending on the level of competition as well.

Improvements in the recording, distribution, streaming and playback systems used in connection with a sporting event can result in more desirable outcomes when those systems are used for events related to charitable causes and may result in an improved environment for raising funds and awareness for the charitable causes.

### SUMMARY

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 shows an example system for capturing streams.

FIG. 2 illustrates capture of several athletic events.

FIG. 3 shows an example environment in which video streams are captured, annotated, and presented to a user.

FIG. 4 shows an example subscriber interface for interacting with the stream selection tool and a donation interface.

FIG. 5 shows a flowchart of one method of annotating video and stream selection.

FIG. 6 is a block diagram of an example of computing hardware that might be used.

FIG. 7 is a block diagram of an example of memory structures as might be used to implement functions described herein.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques described and suggested herein include methods to solve issues related to registering, fundraising, scoring, displaying results, and streaming video for live events, such as sporting events for charity. Other sporting events might also have streaming video for live events, as well as nonsporting events. Example nonsporting events include but are not limited to fashion shows, political rallies and meetings, concerts, festivals, and parades. The system could be used for ceremonies such as weddings, award ceremonies, or birthday parties.

Using the systems described herein, viewers who are also donors can more easily track and view the portions of sporting events that they most care about, such as the performance of athletes they are sponsoring or have some connection to.

In some embodiments, there need not be real-time editors, and the video coverage of the event can be streamed with viewers able to specify which portions of which events—such as only the portions that feature athletes of interest to that viewer—are shown and when.

For example, spectators, competitors, organizers, coaches, etc. may all have different ideas of what portions to watch. Spectators are unlikely to be concerned with a star player but instead want to watch their friends compete. A competitor will likely want to watch a highlight reel focused on their competition. For professional events, humans—camera operators and other broadcasting personnel—make decisions about which camera angle to pick. For charity events or less formal events, there is a need to allow viewers to pick which camera they would like to watch. Embodiments according to the disclosure satisfy this need.

The subscriber interface allows the user or viewer to pick from multiple viewpoints and streams from which to view a particular event. In one embodiment, the user can pick which camera to watch and toggle between streams. Streams (which may correspond to one or multiple cameras) may be attributed to other users, such as a sponsor of a team. For example, a team sponsor may set up a camera at a particularly desirable location (e.g., the 50 yard line of a football game) and tie that to an existing streaming input. One sponsor may have multiple cameras and pick which stream is most desirable for other users. A sponsor or the organizer of an event may set up particular cameras and streams as attributed exclusively to the sponsor or event organizer.

In another embodiment, a user may choose to follow a competitor (e.g., a competitor athlete). By following the one or more subjects or competitors, the viewer is not required to watch an event in its entirety. Instead, the user is notified by alerts prior to the followed competitor's upcoming performance, prompting the user to tune in. After the event is over, a highlight reel may be constructed for each competitor.

In some embodiments, the user may influence the outcome of the events with a charitable donation or other interaction. A viewer may, for example, influence the stakes of a subject's upcoming performance by submitting a performance-based donation based on a performance outcome (e.g., score, ranking, time, etc.) or by making a charitable donation which takes the form of a bet. A user may also purchase products or services advertised on the stream or that appear on the stream. For example, the system may be used to broadcast a fashion show instead of a sporting event and may allow the user to purchase an outfit worn by a model appearing on the selected stream. A user may also be invited to place a wager on the outcome of an event, such as whether a team will score or beat a point-spread. The user interface may display odds to the user and allow the user to input an amount to bet. The bets may be in actual currency connected to a user bank account or in a score keeping system which keeps track of the user's wins and losses but does not involve actual currency.

The system may also, by tagging time periods of streams as part of a competitor's performance, allow stored streams to be distributed to a subject's social media, email, or other channels, thus delivering highlights to a pre-determined audience (e.g., the competitor's followers). The system can record, cut, and consolidate a collection of clips of a subject performing a series of tasks, thereby delivering a personalized highlight reel after the subject's completion of a pre-determined set of tasks.

The system allows advertisers to deliver localized content based on the system's ability to identify a viewer's location. For example, the system could show advertisements for a business that was only in one state only to viewers located in that state.

In one embodiment, the system has schedule data for events and participants. Approximate times for a participant to compete in an event may be provided. This allows the system to construct a table of where every subject is during an event at all times. The data may be combined with the streams to give viewers content such as: Who is participating in what event right now, who is participating in what event next, who participates immediately after a competitor, and who just finished participating in an event. A concert or music festival may be tagged with performance times. Individual performers within groups may be tagged for tracking by, for example, facial recognition.

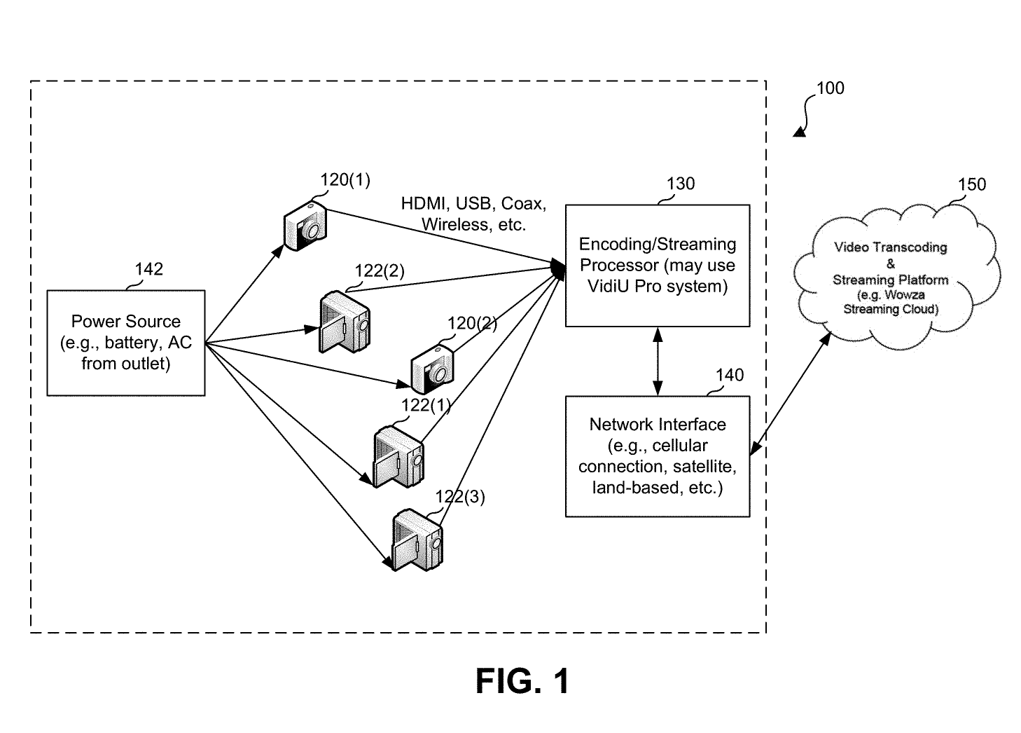

FIG. 1 shows an example streaming system 100 for capturing streams. It comprises a portable or wearable camera 120 (for example, a GOPRO (™)), an encoding and streaming device 130 (for example, a VIDIU PRO (™)), a device 140 that allows the encoder 130 to connect to the Internet (e.g., cellular modem, Wi-Fi), and a power source 142 to power the camera and encoder (e.g., a battery or power outlet).

The raw audio and video from the camera 120 is passed into the encoding and streaming device 130. This device encodes and streams the audio/video to a transcoding and streaming platform video system 150. This video could be streamed to the video system 150 in multiple ways, for example Real-Time Messaging Protocol (RTMP).

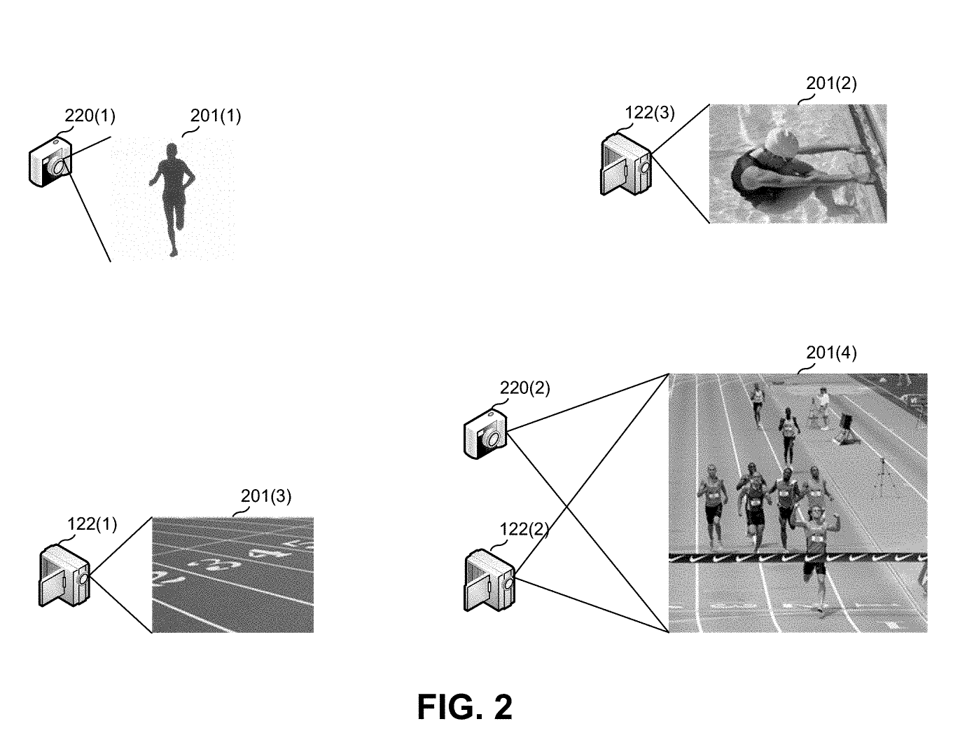

FIG. 2 illustrates capture of several athletic events. Examples might include capturing an image of a marathon runner 201(1), capturing video of a swimmer 201(2), recording a track and field event 201(3), and/or recording by image and video the ending of a running race 201(4). These events are captured by the devices shown in FIG. 1 and in the case of many different sporting events, there might be more content than any one viewer wishes to view.

In a general case, there are multiple events occurring, with participants in these events. The events can be sporting events or other types of events. Control over aspects of the operations might be embedded in a streaming management server that might contain elements shown in FIG. 1 or other figures. As the events occur, cameras (and possibly other recording devices) capture the activity of the events. The streaming management server might be configured to send commands to the recording devices to control what is captured, such as sending a command to a camera to pan and zoom to a particular location. The streaming management server then receives the feeds from these recording devices and can store and/or stream those feeds. The choice of where to stream those feeds might be determined by program code that reads data from one or more databases.

For example, the streaming management server might include a camera database that tracks all the cameras that provide streams, a scheduling database that maintains data about what events are occurring when and who is participating in the event and when they are scheduled to perform, a participant database that includes data about participants and perhaps how to detect when that participant is actually performing (e.g., by face recognition, uniform pattern recognition, RFID tag readings, etc.), and a subscriber database that contains data about subscribers to the streaming system, what participants they want to follow, their viewing schedule, how to ping the subscriber to inform them that there is a live event to be viewed, subscriber demographics, etc. and possibly other databases.

The streaming management server can use those databases to, among other things, send network messages (“pings”) alerting subscribers to “tune in” to their streams, determine which links to send to which subscribers for them to use to request streams, and the like. The streaming management server might also have a database of event particulars in which specific conditions are to trigger alerts to subscribers. Subscribers then get, on their devices or however they choose to get notifications, notifications of streams and can use those devices to request the streams or just get the streams automatically.

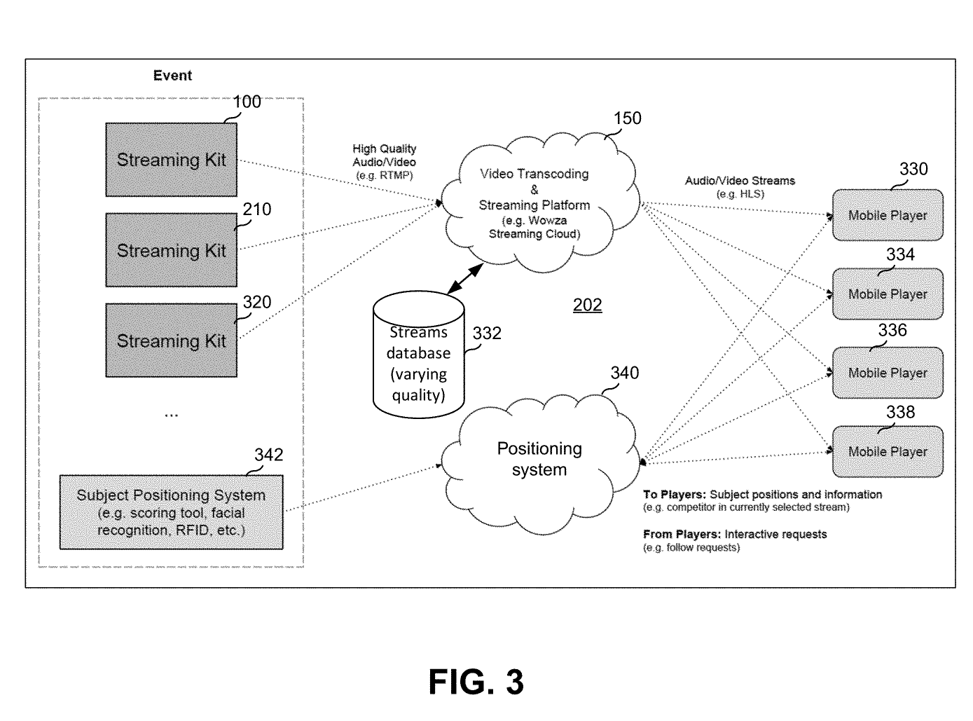

FIG. 3 shows an example environment 202 in which video streams are captured, annotated, and presented to a user. Streaming kit 100 streams data to video system 150.

The video transcoding and streaming video system 150 leverages adaptive bitrate technologies to provide the best-possible quality video stream to a viewer's mobile device 330 given its available bandwidth. The transcoder encodes the incoming stream from the hardware encoder 130 (see FIG. 1) into multiple streams of varying quality and prepares them for adaptive bitrate streaming. The streams may be stored in a streams database 332. This collection of streams is exposed to the mobile player 330, which then selects the appropriate quality stream based on its available bandwidth. One possible transport protocol is HTTP Live Streaming (HLS) for delivering video content to the mobile player. There may be multiple mobile players 330, 334, 336, 338.

The positioning system 340 is a web application that is responsible for the following: facilitating the configuration of video subjects (e.g., competitors); facilitating the configuration of event-facing video streams (one per streaming kit); aggregating multiple event-facing video streams into a single viewer-facing stream; determining when a subject will be performing on a particular stream; distributing notifications for positioning system's “follow” functionality; and distributing information about the subject that is currently on each viewer-facing stream's “stage” to mobile players for display on the player overlay.

Before an event, an operator configures the subjects, their performance order, and any information that will be included in the video overlay in the positioning system (e.g., their name, charity, team information, etc.). They will also configure each event-facing camera, including the URL where each camera's stream can be accessed (when using HLS, this would be the HLS playlist URL).

The positioning system 340 can aggregate multiple event-facing streams into a single user-facing stream depending on an event-specific timeline. For example, in an athletic event, subjects may move between various stations. Examples of such events include marathons, triathlons, fun runs, obstacle courses, and bicycle races. An obstacle course may have particularly interesting vantage points for each obstacle. A “haunted house” amusement may have particularly frightening points in a path through the haunted house and some viewers might want to focus on that aspect of the streams. A camera could be placed at each station, and configured as a single viewer-facing stream in the positioning system 340 along with criteria for when each camera should be live. When a viewer selects one of these aggregate streams, the positioning system 340 will review the current positioning of subjects and other event-specific criteria to determine which event-facing stream to present to the viewer. The player will automatically cut between these event-facing streams as the event progresses.

The positions of subjects are useful for the positioning system's overlay, “follow”, and camera aggregation features. At any point in time, the positioning system 340 may calculate which subjects are performing in each stream. This can be accomplished in a variety of ways.

One way to identify player position is with a software tool 342. One or more operators use a mobile website or application that communicates with the positioning system 340 to establish the progression of subjects throughout the event. For example, during an athletic event, the tool would display a list of all competitors. As each competitor competed in the event, the operator would press a button on the tool marking that competitor as having finished.

Another approach to identify player position is via RFIDs. Each player would carry or wear an RFID tag that uniquely identifies them. When a player entered a predefined zone, an on-site hardware device would update the positioning system 340.

Another approach to identifying player position is facial recognition. The subjects' faces would be configured in the positioning system 340 before the event. During the event, the live stream would be delivered to a facial recognition system, which would update the positioning system as subjects entered each stream's visible stage.

Another approach is to use optical character recognition (OCR) of a competitor's bib number or other worn identification to identify competitors. Competitors would be given bib numbers that were entered into the positioning system 340 before the event. During the event, the live stream would be delivered to the OCR system which would update the positioning system as subjects entered each stream's visible stage.

The system may use a combination of different approaches. For example, information from an RFID may be used to identify what competitors may possibly be in a given frame of video because they are close to the location of a camera, and a facial recognition system may refine the identification by tagging the frame with competitors that are actually in the frame. The system may “clip” the entry of a competitor into the frame as a start position of a video containing the competitor and finish the video when the competitor exits the frame. The clipped videos may be aggregated to form a competitor focused video. The competitor focused video may be automatically or manually pruned to create a highlights reel of the competitor. For example, video taken near portions of an obstacle course that are particularly challenging may be added to the highlights reel. In general, portions of a course or path may be tagged ahead of time as being particularly interesting or challenging. In another embodiment, information from a device worn by a competitor may indicate interesting video portions. If the competitors are wearing devices with accelerometers, periods of high acceleration may be added to the highlights. If the competitor is wearing a heartbeat monitor, periods of high heartbeat may be added to the highlight reel. At the conclusion of the event or shortly thereafter, a personalized (e.g., specific to each competitor) highlight reel may be automatically provided to each participant or subscribers, for example by emailing or posting to social media the video or a link to the video.

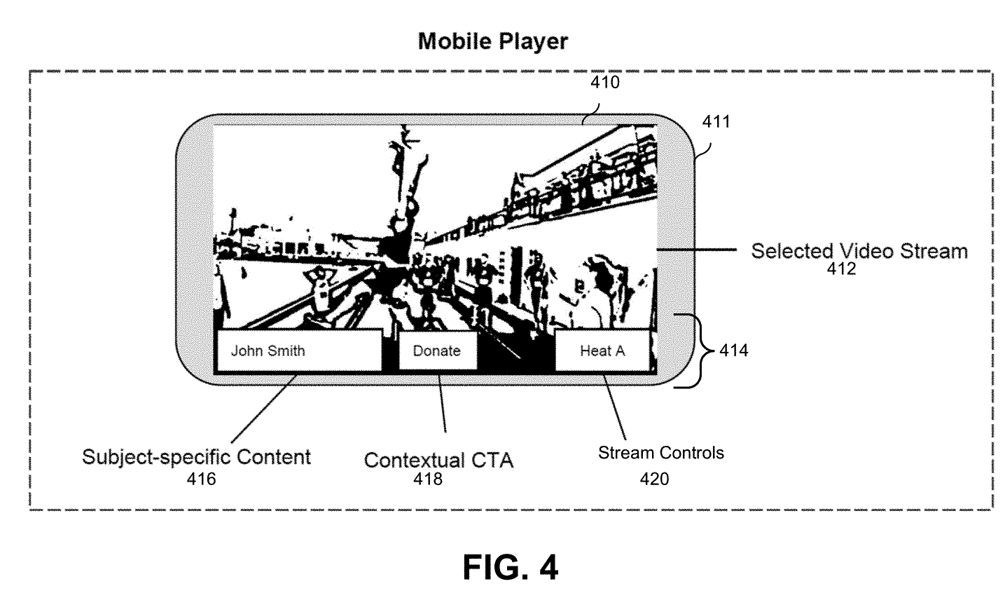

FIG. 4 shows an example of a subscriber interface 410 running on a mobile device 411. In the example embodiment, the subscriber interface is for a mobile device, such as a smartphone, but may also be for a standard desktop, such as via a web browser. The mobile player 411 may be substantially identical to the mobile devices 330, 334, 336, and 338 of FIG. 3. The subscriber interface is comprised of two layers: a video stream 412 and an informative and interactive overlay 414. In one embodiment, the interface is web-based and leverages standard web technologies. In other embodiments, the subscriber interface could be built into a native application for a mobile or desktop operating system. The top (“overlay”) layer 414 contains subject-specific information 416, calls to action 418, and stream controls 420. The stream controls may include, for example, a stream selector. The video system 150 (see FIG. 1 and FIG. 3) exposes real-time stream and event data to the player 411. Event data may be transferred via a standard object notation such as JSON. The subscriber interface 410 regularly polls for the video system 150 for an updated list of available streams and their associated URLs (e.g. HLS playlists). The subscriber interface 410 may also subscribe to events and receive push messages updating the available streams. Updating the aggregate streams frequently keeps the URLs up to date, as the URLs may change throughout an event as the system 150 cuts between multiple event-facing streams coming from multiple event streaming kits 100, 210, 320. The subscriber interface 410 also polls the video system 150 for updated overlay information for the currently selected stream. Since the video system 150 knows which subjects are on each camera's “stage”, this payload always contains information pertaining to content that the viewer is currently watching.

The subscriber interface 410 also includes “follow” functionality, which allows viewers to create subscriptions for specific subjects. When a viewer first accesses the subscriber interface 410, the video system 150 generates a “viewer” record in its database for that viewer and stores their unique ID in a cookie on their device. Later, when that viewer clicks or taps the “follow” button in the player overlay, they are prompted to enter an optional mobile number, and the player sends an API request to the video system 150, which creates a subscription record for that viewer for the subject that is currently in their view. Since subject ordering is configured before the event, the video system 150 can establish when a subject will be performing soon based on which subject is performing right now. Each time a subject begins their performance, the video system 150 dispatches notifications to any viewers who are following the subject that will be performing soon (as defined on a per-event basis in the backend). Notifications may be sent via SMS text message if the viewer opted to provide a mobile number. Notifications may also be sent by email or by notifications in a dedicated mobile application. The subscriber interface 410 may also poll a notifications API endpoint, which includes followed subject notifications, which are displayed by the subscriber interface 410.

Individual viewer identification also allows the video system 150 to store event and viewer-specific information. For example, if a particular event includes a call to action to make a purchase from with the subscriber interface 410, the video system 150 could store payment information associated with the viewer so that they would not need to enter it for subsequent purchases.

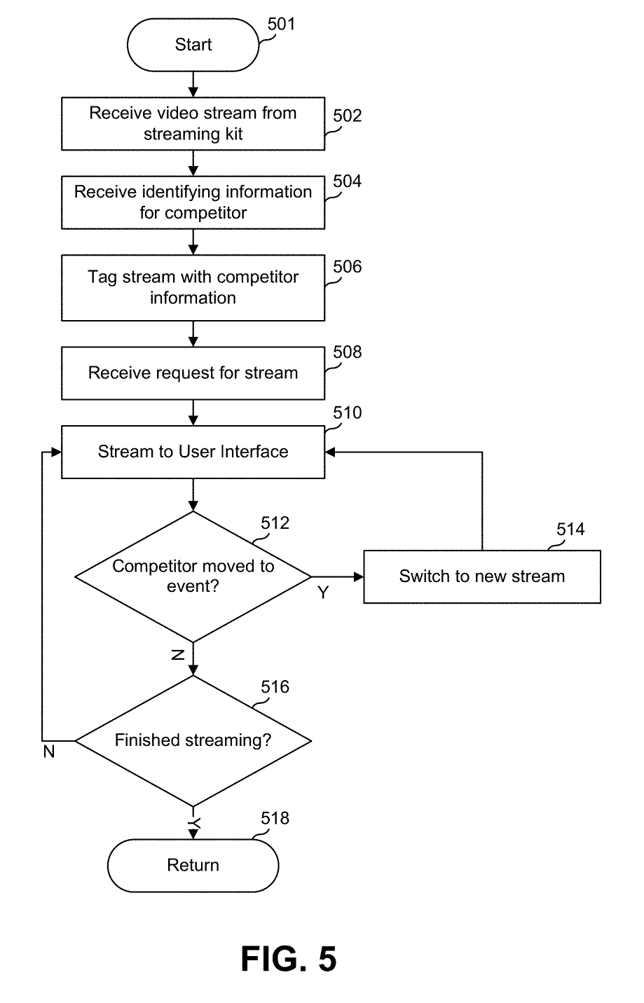

FIG. 5 is a flowchart of a process for capturing and selecting a video stream for a user. In this embodiment, a user of the subscriber interface has selected the “follow” mode. This process might be executed in the environment 202 of FIG. 3. The method starts at 501. In step 502, video system 150 receives the video stream from a streaming kit or stand-alone camera. In step 504, the positioning system 240 receives identifying competitor information. In step 506, video system 150 tags the received video stream with competitor information. In step 508, the video system 150 receives a request for a stream from a subscriber interface system 410 running on a mobile device 411. In step 510, the video system requests the competitors' information from the positioning system 340 and serves the stream corresponding to the competitor to the subscriber interface 410 on the mobile device 411.

If the user requested to follow a competitor via the “follow” mode, the stream will change when the competitor moves events. In one embodiment, in step 512, the system polls the video system 150 for updates on the competitor. If the competitor has moved to a new event, and therefore to a new stream, then, at step 514, the subscriber interface 310 will switch to a new stream. If the competitor has not moved, then, at 516, system checks if the user has indicated to the subscriber interface that the user no longer wants to stream video. If the user has turned off streaming, then, at 518, the method ends. If the user wishes to keep streaming, then the method continues at 510.

### Examples of Use Cases

A. Following a Specific Athlete or Other Recorded Person/Action

Suppose a subscriber to a video streaming system determines that they cannot always watch all available content and instead the user would like to “follow” several athletes (or other person, in the case where it is not a sporting event), wherein the subscriber obtains a feed of video streams involving one or more of those athletes. That way, the subscriber can view or scroll through video streams and watch those of particular interest. The subscriber might also prefer to be notified so that these snippets of events could be viewed live. It should be understood that in this context, “live” could also encompass streams that are substantially live wherein a delay between the occurrence of an action and the viewing of that action is not totally simultaneous, but is delayed perhaps by some processing and transmission time, but not so much that viewers would not consider the presentation to be a live presentation.

In this embodiment, perhaps there is a subscriber who likes one member of a sports team and wants to follow the activities of that member, but dislikes the team itself. That subscriber could update their user record in the user database that a streaming management server might maintain. As the streaming management server also maintains a database of appearances, it would know when to send an alert to that subscriber. The streaming management server might send out a text message to a subscriber telephone number stored in the user record informing the subscriber that the followed athlete is up to play and when the subscriber responds to the prompt, the video stream of the followed athlete plays and then video display ends. This might be affected as a mobile app, wherein the streaming management server sends a signal to the mobile app running on a device of the subscriber, which then would trigger the operating system of the device to notify the subscriber with a sound or visual prompt. The subscriber might then open the mobile app to view the streaming video.

In this manner, a subscriber can selectively “follow” particular individuals and be alerted to their performances in real-time for live viewing. It may be that there are multiple video streams to follow and they may overlap in live time. For example, there might be a track and field event that stages many different events that overlap in time. If a subscriber were following two athletes, say a high jumper and a 100 m sprinter and the high jumper happens to start their performance at the same time as the sprinter is sprinting, the streaming management server might alert the mobile app and coordinate with the mobile app so that the mobile app notifies the subscriber, the mobile app presents streaming video of the high jumper performing a high jump, finishes that streaming video and immediately starts playing the 100 m dash, delayed slightly due to the high jump, and then stops. This allows the subscriber to be doing something else, pause briefly to view the two events, and then return to what the subscriber was doing before. In this manner, the subscriber could get feeds of just the performances of interest to that subscriber.

B. Following a Specific Person in a Group

Suppose a parent is travelling and unable to attend a child's performance in a school play in person. The streaming management server might manage feeds from the school auditorium and maintain a schedule of who will be appearing when, so that the remote parent can be alerted when their child's part comes up so they can watch that, if they are not able to watch the entire presentation.

C. Conditional Following

Suppose a subscriber wishes to follow portions of an American football game, but only those portions where their favorite running back is lined up for a play or where the game is a close game. Selecting by the favorite running back can be done as provided above. As explained herein, the streaming management server would keep track of scheduled performances as well as using RFIDs, pattern matching, manual input, or other techniques for determining when a person will be performing. However, the subscriber might also input a preference to only be alerted if some other condition is present.

For example, suppose that Team A and Team B are playing each other and Team B is favored to win by 6 points. A subscriber who is a fan of Team B might want to stop watching if the score is 7-28 in favor of Team B, but would go back to watching if the score changed to where Team B was at least within 10 points of Team A and there were at least M minutes left to play in the game, or where the two teams are within the spread or nearly so. With those preferences specified, such as rules in the user record at the streaming management server, and inputs to provide running scores and the like, the streaming management server can then time alerts to those subscribers when and if the condition comes to pass.

D. Conditional Advertising

With sufficient numbers of subscribers, the operators of the streaming management server would be able to determine contingent audiences. For example, if the user database indicated that 80,000 subscribers would be interested in rejoining the viewing of a sporting event if a Criterion C changed from false to true, then certain characteristics can be inferred about those subscribers and their future actions. If the rules that subscribers set for themselves closely match what wagering services post for wagers, such as point spreads, then it might be inferred that the subscriber's main interest is in wagering. If the rules that subscribers set for themselves are that a certain team must not be losing by very much, then it might be inferred that the subscribers are fans of that team. Other demographics and perhaps geographical location for the subscribers' devices might be used as well to infer characteristics of the contingent audience.

Advertisers could be asked to bid on the rights to present advertisements to contingent audiences, should it come to pass that Criterion C comes true. Criterion C might be that a certain score is reached, a certain relative score is reached, or some game event occurred (such as where the winning run is on base in baseball, or that a particular quarterback has unexpectedly left the game thus changing game dynamics, or a tennis match as gone on twice as long as is typically—suggesting an interesting match). The pricing for bids on advertising to the contingent audience might be at one level before the contingency is met, which might be lower to reflect the fact that the contingency might never be met and thus the contingent audience might never materialize, and be at a higher rate if advertising time was not secured until after the contingency is met.

Historical data might be maintained for the streaming management server to track how many subscribers or what percentage of subscribers stop watching an event, set a rule with criteria for getting notifications, and when they get the notification, they return to watching the event. This can be used to inform potential advertisers. For example, an advertiser might not want to take a chance on missing out and will place an order for an advertisement directed to a contingent audience knowing that 95% of the subscribers who set up a rule and are thus in the contingent audience will return to viewing if the contingent criteria are met.

### Example Hardware Infrastructure

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

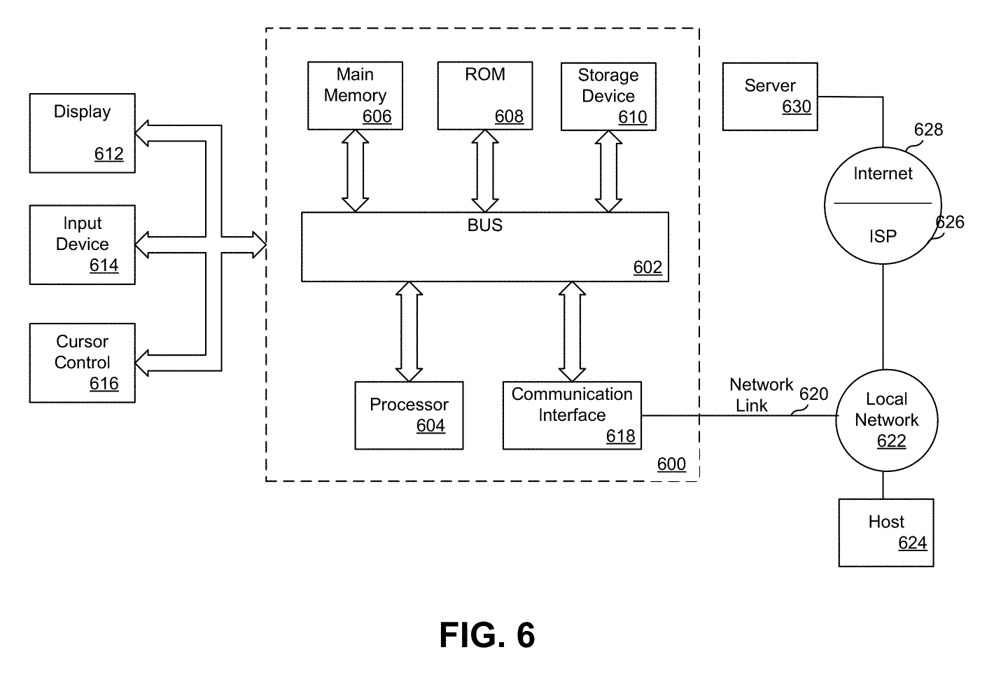

For example, FIG. 6 is a block diagram that illustrates a computer system 600 upon which an embodiment of the invention may be implemented. Computer system 600 includes a bus 602 or other communication mechanism for communicating information, and a processor 604 coupled with bus 602 for processing information. Processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a computer monitor, for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a network connection. A modem or network interface local to computer system 600 can receive the data. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

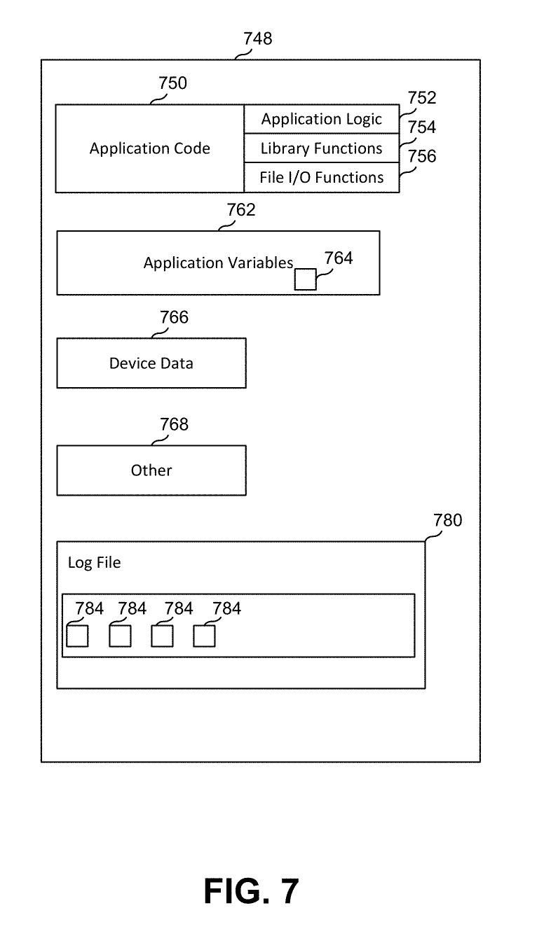

FIG. 7 illustrates an example of memory elements that might be used by a processor to implement elements of the embodiments described herein. For example, where a functional block is referenced, it might be implemented as program code stored in memory. FIG. 7 is a simplified functional block diagram of a storage device 748 having an application that can be accessed and executed by a processor in a computer system. The application can one or more of the applications described herein, running on servers, clients or other platforms or devices and might represent memory of one of the clients and/or servers illustrated elsewhere. Storage device 748 can be one or more memory devices that can be accessed by a processor and storage device 748 can have stored thereon application code 750 that can be configured to store one or more processor readable instructions. The application code 750 can include application logic 752, library functions 754, and file I/O functions 756 associated with the application.

Storage device 748 can also include application variables 762 that can include one or more storage locations configured to receive input variables 764. The application variables 762 can include variables that are generated by the application or otherwise local to the application. The application variables 762 can be generated, for example, from data retrieved from an external source, such as a user or an external device or application. The processor can execute the application code 750 to generate the application variables 762 provided to storage device 748.

One or more memory locations can be configured to store device data 766. Device data 766 can include data that is sourced by an external source, such as a user or an external device. Device data 766 can include, for example, records being passed between servers prior to being transmitted or after being received. Other data 768 might also be supplied.

Storage device 748 can also include a log file 780 having one or more storage locations 784 configured to store results of the application or inputs provided to the application. For example, the log file 780 can be configured to store a history of actions.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above- disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of selecting a video stream for viewing from a plurality of video streams capturing imagery of a plurality of real-world events, the method comprising:
receiving the plurality of video streams from a plurality of video cameras, each of which is configured to provide a video stream of an event of the plurality of real-world events;
receiving an identifier and identifying information for each of a plurality of participants;
obtaining user input from a user indicating a preference for a selected participant;
receiving participant-event information which maps timing of the selected participant participating in an event of the plurality of real-world events or visibility of the participant to a particular video camera of the plurality of video cameras;
calculating participant-stream information, wherein the participant-stream information associates the selected participant with a stream based on the participant-event information;
constructing a selected video stream from the participant stream information and the plurality of video streams for at least the selected participant; and
sending the selected video stream to one of an email address or a social media account associated with the user.

2. The method of claim 1, wherein the participant-event information includes at least one of a schedule of the real-world events, facial recognition information for at least one participant, optical character recognition, and RFID information for at least one participant.

3. The method of claim 1, wherein a highlight reel is constructed from the selected video stream by clipping the selected video stream based on tagging a location in a path of an event of the real-world events.

4. The method of claim 1, wherein the selected video stream is constructed by combining participant stream information with information from a device worn by competitors.

5. The method of claim 1, wherein the plurality of real-world events are events of a sports competition, wherein the plurality of participants comprises a plurality of competitors, and wherein the selected video stream constructed focuses on one of the plurality of participants as the one participant progresses through the sports competition.

6. The method of claim 1, wherein the plurality of real-world events are events of a sports competition, wherein the plurality of participants comprises a plurality of competitors, and wherein the participant-event information further includes scoring information from a scoring tool.

7. The method of claim 1, wherein the plurality of real-world events are events of a charity event and wherein the method further comprises receiving from a video subscriber interface device one of: (1) a rating of an entertainment value of selected content, (2) a donation, (3) a contingent donation amount that is contingent on a performance outcome of an event, and (4) a purchase of a product or service.

8. The method of claim 1, wherein the user input is obtained from a video subscriber interface device which is one of a web browser and a smartphone.

9. A computer video system for selecting a video stream for viewing comprising:
a plurality of video cameras each configured to produce a video stream of a real world event thereby producing a plurality of video streams;
a streaming management server configured to receive the plurality of video streams from the plurality of video cameras, the streaming management server further configured to:
(a) receive identifying information for each of a plurality of participants;
(b) receive participant-event information which maps participant participation in an event or visibility of a participant to a particular video camera of the plurality of video cameras;
(c) calculate participant-stream information, wherein the participant-stream information associates participants with streams based on the participant-event information; and
(d) identify a participant stream information and the plurality of video streams for a selected participant; and
a video subscriber interface device which provides a subscriber interface configured to allow a user to request a filtered stream associated with the selected participant.

10. The computer video system of claim 9, wherein participant-event information includes at least one of a schedule of events, facial recognition information for at least one participant, optical character recognition, a device worn by at least one participant, and RFID information for at least one participant.

11. The computer video system of claim 9, wherein the streaming management server is further configured to construct a highlight reel from the filtered stream based on tagging information identifying locations visible to at least one video camera of the plurality of video cameras.

12. The computer video system of claim 9, wherein the real world event is a sporting event, wherein the plurality of participants comprises a plurality of competitors, and wherein the filtered stream focuses on the selected participant progressing through the sporting event.

13. The computer video system of claim 9, wherein the ongoing live event is a sporting event, wherein the plurality of participants comprises a plurality of competitors, and wherein the participant-event information includes scoring information from a scoring tool.

14. The computer video system of claim 9, wherein the ongoing live event is a charity event and wherein the method further comprises receiving from the video subscriber interface device one of: (1) a rating of an entertainment value of selected content, (2) a donation, (3) a contingent donation amount that is contingent on a performance outcome of an event, and (4) a purchase of a product or service.

15. The computer video system of claim 9, wherein the video subscriber interface device is a smartphone and a web browser.

16. A method of selecting a video stream for viewing, the method comprising:
receiving a plurality of video streams from a plurality of video cameras, each of which is configured to provide a video stream of an ongoing live event;
receiving identifying information for each of a plurality of participants;
receiving participant-event information which provides information about visibility of a participant to a particular video camera of the plurality of video cameras;
calculating participant-stream information, wherein the participant-stream information associates a participant with a stream;
in response to a request from a video subscriber interface device, constructing a participant video stream from the participant stream information and the plurality of video streams for at least one participant; and
sending the participant video stream to the video subscriber interface device.

17. The method of claim 16, wherein the participant-event information further includes one of a schedule of events, facial recognition information for at least one participant, optical character recognition identifying a tag on at least one participant, and RFID information for at least one participant.

18. The method of claim 16, wherein participants are associated with streams based on facial recognition of the participants.

19. The method of claim 16, further comprising receiving from the video subscriber interface device a contingent donation amount that is contingent on an outcome of an event in the ongoing live event.

20. The method of claim 16, wherein the selected video stream is constructed by combining participant stream information with information from a device worn by competitors.
